(19) United States
(12) Patent Application Publication
(10) Pub. No.: US 2009/0284829 A1
(43) Pub. Date: Nov. 19, 2009

(54) PLASMONIC ELEMENTS

(76) Inventors: Christopher L. Bower, Cambridgeshire (GB); William J. Harrison, Pittsford, NY (US); Anatoly V. Zayats, Belfast (GB); Robert J. Pollard, Bangor (GB); Gregory A. Wurtz, Belfast (GB); Paul Evans, Belfast (GB)

Correspondence Address: EASTMAN KODAK COMPANY;PATENT LEGAL STAFF, 343 STATE STREET, ROCHESTER, NY, 14650-2201, US

(21) Appl. No.: 12/440,770

(22) PCT Filed: Aug. 31, 2007
(86) PCT No.: PCT/GB07/03287

§ 371 Date: Mar. 11, 2009

(30) Foreign Application Priority Data
Sep. 12, 2006 (GB) 0617878.4
May 30, 2007 (GB) 0710245.2

(51) Int. Cl. G02F 1/35

(52) U.S. Cl. 359/326

(57) ABSTRACT

A surface plasmon element comprising an array of metal nanoparticles (1) with an adsorbed layer of resonant material and the use of such material to activate said array.

### FIELD OF THE INVENTION

This invention relates to the field of surface plasmon elements.

### BACKGROUND OF THE INVENTION

Surface plasmon polaritons (SPPs) are surface waves resulting from the coherent oscillation of conduction electrons. They are therefore strongly confined to the interface between a metal and a dielectric. The strong confinement offers the possibility of creating sub-wavelength optical waveguides and components. These are much smaller than the wavelength of light in the dielectric and therefore much smaller than conventional photonic or dielectric waveguides. The reduced size and the use of conductive materials allows for much closer integration with conventional micro-electronic devices, since it is possible to transmit both optical and electrical data within the same waveguide. To enable a fully integrated sub-wavelength optical platform, it is also necessary to be able to control and manipulate light using external control signals. This requires active devices such as optical transistors, optical modulators, lasers and optical filters. There are various ways in which the amount of light that is allowed to pass through such a device can be realised, such as changes in the degree of coupling to plasmon modes, refractive index changes, or other controllable changes in physical properties.

SPPs are known for use in a variety of applications such as integrated optics, magneto-optical data storage, solar cells, and in sensing systems such as surface-enhanced Raman spectroscopy (SERS), which is capable of molecular detection down to the level of a single molecule (Kneipp, K. et al. Phys. Rev. Lett. 78, 1667-1670 (1997)). U.S. Pat. No. 6,862,396 describes metal nano-structures capable of converting light into surface plasmons on a plasmon supporting structure, then re-emitting the light.

It is also known that arrays of sub-wavelength holes created in a metallic film can act as an optical switch when coated with a thin film of polymer, such as polydiacytylene, that has a refractive index that changes when illuminated with light of a certain wavelength (I. I. Smolyaminov, A. V. Zayats, A. Gungor, and C. C. Davis, Phys. Rev. Letters 88, 187402 (2002), G. Wurtz, R. Pollard, and A. Zayats, Phys. Rev. Lett. 97, 057402 (2006)). Light is transmitted through the holes by coupling into surface plasmon modes, the degree of coupling can be modulated by the presence of a non-linear material. US 2006/0078249A1 describes an optical transistor that uses sub-wavelength apertures created in a conductor. By creating periodic perturbations in the electromagnetic environment of the conductor it is possible to control the transmission of light through the apertures. U.S. Pat. No. 6,977,767B2 describes an optical transistor, modulator or filter that uses non-periodic nanoholes in an optically thick conductive film to control light transmission, by two control light beams. U.S. Pat. No. 6,611,367 describes a plasmonic optical modulator based on total internal reflection from a silver film with a photo-functional coating containing organic dyes.

### PROBLEM TO BE SOLVED BY THE INVENTION

To realise all-optical integrated circuits that are small enough to be integrated with existing micro-electronics it is necessary to be able to manipulate radiation at the nanoscale with structural elements smaller than the wavelength of the radiation. Such plasmonic all-optical integrated circuits first of all require the creation of nanometre scale metallic tracks or chains of nanoparticles or nanowires to form plasmon waveguides. A further requirement is the ability to actively switch, modulate or filter the light intensity in such a plasmonic circuit, using an optical transistor, or generate light using a laser. In addition, the manufacture of these elements must be scaleable and cost-effective.

To create active devices the nanoparticles must be functionalised with a non linear material. One suitable non-linear material is a liquid crystal such as E7 (Merck). Another typical non-linear material is a polymer such as polydiacetylene (3BCMU), used due to its large and rapid change in dielectric constant depending upon the wavelength of light it is illuminated with. However the adhesion of this material to the metallic films used to sustain plasmons is poor. A commonly used alternative to this polymer is to use an organic dye such as (5,5′,6,6′-tetrachloro-1-1′-diethyl-3,3′-di(4-sulfobutyl)benzimidazolocarbocyanine (hereinafter TDBC)) that forms a j-aggregate, since it is known that such materials couple strongly with the surface plasmon modes. However TDBC also adheres poorly to the plasmon-sustaining metal layer, requiring the use of adhesion layers such as TiO₂ or polymeric binders such as polyvinyl alcohol.

It is possible to create plasmon waveguides and optical elements in a scaleable cost-effective manner using a patterned array of nanoparticles with controllable size and morphology as described by the methods described in GB 0611557, the contents of which are incorporated herein. Furthermore, GB 0611560, the contents of which are incorporated herein, describes how the methods of GB0611557 can be used to create plasmon waveguides, transistors, sensors and lasers. In order to create optically active devices such as these, the nanoparticles are functionalised with a non-linear material. The non-linear, or resonant, material is an organic dye created so as to have the ability to spontaneously form j-aggregates when deposited onto nanoparticles of noble metal, and to form a strong bond with the metallic nanoparticles. The non-linear material can also be a liquid crystal in contact with the nano particles, whose optical properties can be controlled by the application of an electric field.

### SUMMARY OF THE INVENTION

According to the present invention there is provided a surface plasmon optical element comprising an array of metal nanoparticles with an adsorbed layer of resonant material.

The invention also provides the use of a resonant material to activate an array of metal nanoparticles to function as a surface plasmon optical element.

In one preferred embodiment the material is a j-aggregate dye. In another embodiment the material is a liquid crystal in contact with the metal nanoparticles, the optical properties of which can be changed by application of an electric field.

### BRIEF DESCRIPTION OF THE DRAWINGS

FIG. 1 is a graph illustrating the results of extinction versus wavelength for the nanoparticle and dye device;

FIG. 2 is a schematic view of the nanoparticle system:

FIG. 3 is a schematic view of an electrically-switchable plasmonic filter; and

FIG. 4 is a graph illustrating the results of extinction versus wavelength for the electrically switchable plasmonic filter.

### DETAILED DESCRIPTION OF THE INVENTION

The preferred method of practising the invention is to create a plasmonic element in a scaleable cost-effective manner using a patterned array of nanoparticles according to the methods described in GB 0611557 and GB 0611560. The advantageous material used in this embodiment is an organic dye created so as to have the following beneficial properties; first the ability to spontaneously form j-aggregates when deposited onto nanoparticles of noble metal, and second to form a strong bond with the metallic nanoparticles. In the following enabling example the dye used was benzothiazolium, 5-chloro-2-(2-((5-chloro-3-(3-sulfopropyl)-2(3H)-benzothiazolylidene)methyl)-1-butenyl)-3-(3-sulfopropyl)-, inner salt, compound with N,N-diethylethanamine (1:1) (structure (9)). However it will be understood by those skilled in the art that the invention is not limited to this material.

Thus any suitable material with the relevant properties can be used and in particular dyes as described in U.S. Pat. No. 6,013,430 of the general formula (I):—

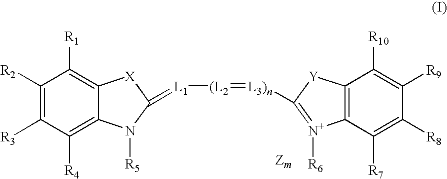

wherein

X and Y each independently represents O, S, Se, a NR group or CH═CH, wherein R represents an unsubstituted or substituted alkyl group, an unsubstituted or substituted aryl group or an unsubstituted or substituted heteroaryl group, with the proviso that at least one of X and Y is S;

R₁-R₄ and R₇-R₁₀ each independently represents hydrogen or a substituent selected from halogen, an unsubstituted or substituted alkyl or alkoxy group having from 1 to 6 carbon atoms, an unsubstituted or substituted aryl group having from 6 to 10 carbon atoms or an unsubstituted or substituted heteroaryl group having from 5 to 10 atoms which may include one or more atoms selected from N, S and O; wherein any two adjacent substituents in R₁-R₄ and R₇-R₁₀ may be taken together to form an unsubstituted or substituted ring;

R₅ and R₆ each independently represents an unsubstituted or substituted alkyl group having from 1 to 6 carbon atoms;

L₁, L₂ and L₃ each independently represents an unsubstituted or substituted methine group;

Z represents an inorganic or organic cation;

n is 0-3 and

m is 0 or 1.

In formula (I), X and Y are preferably S or O atoms and more preferably each of X and Y is a S atom. R may be, for example, a methyl, ethyl, propyl or methoxyethyl group. R₁-R₄ and R₇-R₁₀ may each independently be, for example, a chloro, bromo, iodo, methyl, ethyl, propyl, methoxyethyl, methoxy, ethoxy, phenyl, tolyl or pyrrolo group. Two adjacent groups in R₁-R₄ and R₇-R₁₀ may combine to form, for example, an unsubstituted or substituted phenyl ring or a ring comprising, for example a —O—CH₂—O— grouping.

R₅ and R₆ may be independently, for example, a methyl, ethyl or propyl group or an alkyl group substituted with an acid or acid salt group, such as with a carboxy, sulfo, phosphato, phosphono, sulfonamido, sulfamoyl or acylsulfonamido group. The terms acid or acid salt group do not include esters where there is no ionizable or ionized proton.

Particularly preferred substituents on R₅ and R₆ include, for example, carboxy and sulfo groups (for example, 2-sulfoethyl, 3-sulfobutyl, 3-sulfopropyl, 4-sulfobutyl, 2-hydroxy-3-sulfopropyl group, carboxymethyl, carboxyethyl or carboxypropyl groups). Bis-sulfonated dyes, such as wherein each of R₅ and R₆ is a sulfopropyl group, are often preferred because of their aqueous solubility characteristics, i.e. as water or aqueous gelatin solubility and formulation. It is generally preferred that R₅ and R₆ are the same. However R₅ may be, for example, a sulfopropyl group and R₆ may be an ethyl group, providing a zwitterionic dye. Cationic dyes (e.g. wherein R₅ and R₆ is each an alkyl group) and zwitterionic dyes generally have a lower solubility than the anionic sulfonated dyes but can still J-aggregate when adsorbed onto a substrate.

The methine chain, L₁-(L₂=L₃), may be substituted, for example, with an unsubstituted or substituted alkyl group of from 2 to 6 carbon atoms. Z may be either an inorganic or organic cation, such as, for example, triethylammonium, potassium or sodium cation or it may be absent depending on the number of charged groups in R₅ and R₆.

The substituents X, Y, n, and R₁-R₁₀ may be selected in order to achieve a surface adsorbed J-aggregated dye wherein the dye's absorbance maximum in the adsorbed state is bathochromically shifted from its absorbance maximum in the molecularly dispersed, non-aggregated state measured in methanol, such that the surface-adsorbed J-aggregate absorbance envelope exhibits (substantial) overlap with the plasmon resonance band of the supporting substrate. Preferably the absorbance wavelength of the substrate-adsorbed dye is shifted 10 nm or more relative to the absorbance wavelength measured for the molecularly dissolved dye in solution in the absence of the supporting substrate.

The nature of the X and Y substituents, (in addition to the length of the polymethine chain linking the two heterocycles and also the nature of groups on the phenyl rings) controls the absorption wavelength of the dye. For a given chromophore (all other things being equal), for example, a symmetrical sulfur, sulfur (benzothiazole) cyanine dye would absorb deeper than an oxygen, oxygen (benzoxazole) cyanine dye. For a particular device application it may be necessary to fine-tune the absorption wavelength of the J-aggregated dye to match the plasmon resonance of the substrate by changing the X and Y substituents (or the length of the bridging methine chain or the phenyl ring substituents, for example by replacing a chloro atom with a methoxy group). Such variations in substituents for this purpose would be well known to one skilled in the art.

Preferably the compound of formula (I) is symmetrically substituted about the methine chain.

Specific examples of preferred cyanine dyes for use in this invention are listed below.

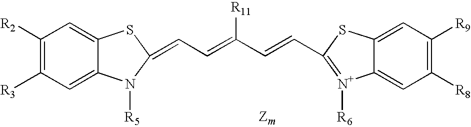

| Dye | R₂ | R₃ | R₅ | R₆ | R₈ | R₉ | R₁₁* | Z** |
|---|---|---|---|---|---|---|---|---|
| 1 | H | Cl | (CH₂)₃SO₃⁻ | (CH₂)₃SO₃⁻ | Cl | H | CH₃CH₂ | (C₂H₅)—NH— |
| | | | | | | | | [CH—(CH₃)₂]₂⁺ |
| 2 | H | 1-pyrrolo | (CH₂)₃SO₃⁻ | (CH₂)₃SO₃⁻ | 1-pyrrolo | H | CH₃CH₂ | (C₂H₅)₃NH⁺ |
| 3 | H | CH₃O | (CH₂)₃SO₃⁻ | (CH₂)₃SO₃⁻ | CH₃O | H | CH₃CH₂ | (C₂H₅)₃NH⁺ |
| 4 | Cl | Cl | (CH₂)₃SO₃⁻ | (CH₂)₃SO₃⁻ | Cl | Cl | CH₃CH₂ | (C₂H₅)₃NH⁺ |
| 5 | H | H | CH₂CHOH— | CH₂CHOH— | H | H | CH₃CH₂ | K⁺ |
| | | | CH₂SO₃⁻ | CH₂SO₃⁻ | | | | |
| 6 | H | Cl | C₂H₅ | (CH₂)₃SO₃⁻ | Cl | H | CH₃CH₂ | — |
| 7 | H | Cl | C₃H₇ | (CH₂)₃SO₃⁻ | Cl | H | CH₃CH₂ | — |
| 8 | H | H | CH₃ | CH₂CHOH— | H | H | CH₃CH₂ | — |
| | | | | CH₂SO₃⁻ | | | | |

*R¹¹ can be an unsubstituted or substituted alkyl group of from 2 to 6 carbon atoms
Z** may be either a cation or absent depending on the number of charged groups in R₅ and R₆

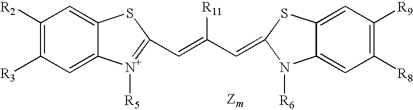

| Dye | R₅ = R₆ | R₃ | R₂ | R₈ | R₉ | R₁₁ | Z |
|---|---|---|---|---|---|---|---|
| 9 | (CH₂)₃SO₃⁻ | Cl | H | Cl | H | CH₃CH₂ | (C₂H₅)₃NH⁺ |

| | | | | | |
|---|---|---|---|---|---|
| 10 | (CH₂)₃SO₃⁻ | —OCH₂O— | —OCH₂O— | CH₃CH₂ | (C₂H₅)₃NH⁺ |

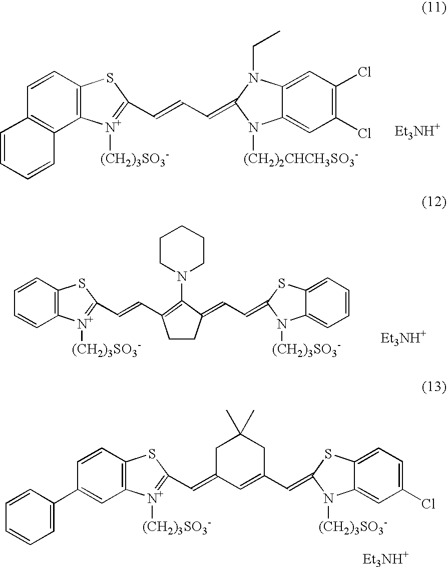

From the dyes in the above, dye 9 is particularly preferred with the full structure shown below:

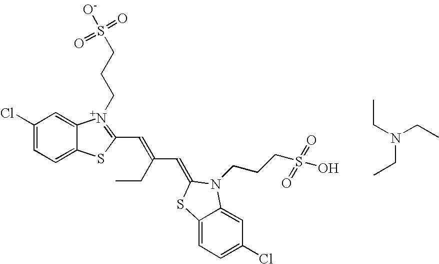

In another embodiment of the invention an electrically switchable plasmonic filter device is created. In this case a liquid crystal in contact with the metal nano particles is used to modulate the optical absorbance of the device.

The principles of the invention are illustrated in the following examples.

### EXAMPLES

### 1. Transistor, Switch Modulator, Sensor and Filter

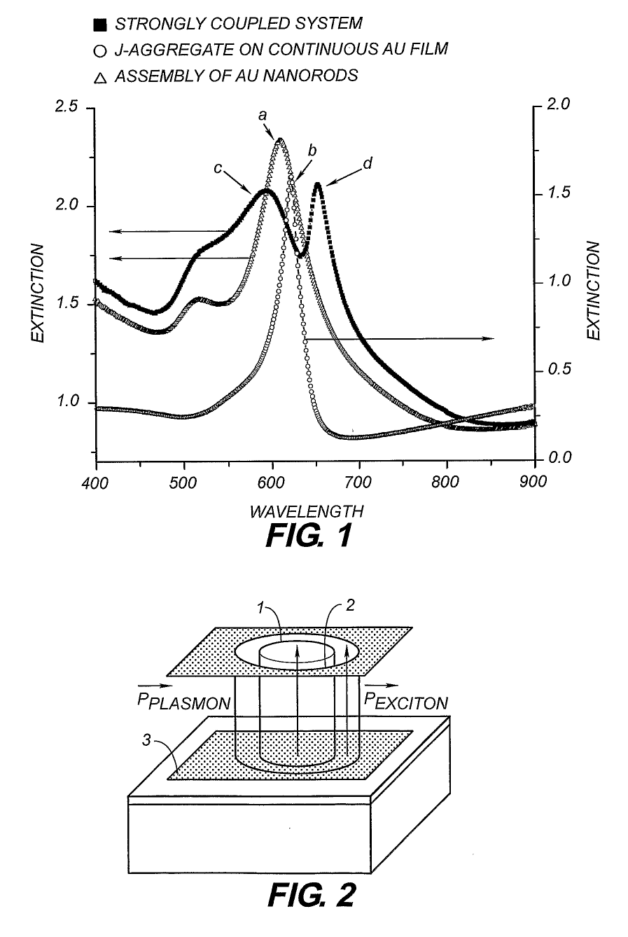

FIG. 1 shows the extinction spectrum of an assembly of Au nanowires strongly electromagnetically coupled to the transition dipole moment of the J-aggregate dye, namely benzothiazolium, 5-chloro-2-(2-((5-chloro-3-(3-sulfopropyl)-2(3H)-benzothiazolylidene)methyl)-1-butenyl)-3-(3-sulfopropyl)-, inner salt, compound with N,N-diethylethanamine (1:1) (CAS no. 27268-5-4)

FIG. 2 shows a schematic representation of the geometry of the system; nanowire 1 is surrounded by a dielectric material 2. The nanowire is perpendicular to a substrate 3.

FIG. 1 also shows the extinction spectrum of the isolated Au nanowires (plasmonic modes) and J-aggregate (excitonic mode) systems. In the particular case of FIG. 1 the two entities are coherently coupled in the hybrid system and the peaks labelled a and b of the isolated systems are entangled in the peaks c and d of the coupled system. The peaks c and d, which share both plasmonic and excitonic properties, are therefore interdependent. As a direct consequence, the addressing of any spectral component within the spectral range covered by c and d will affect the amplitude and shape of the spectrum in the entire spectral window covered by these two resonances. This effect would occur with an enhanced sensitivity scaling with the strength of the coupling. This unique behaviour can be used to produce a number of optical functionalities such as optical modulation, switching, filtering or sensing.

The transistor, for example, may operate by using a low intensity probe beam to illuminate the coupled system at a wavelength of 550 nm in FIG. 1. This would modify the coupling strength within the hybrid structure and strongly modify its optical signature in the spectral range between 550 nm and 700 nm enabling to control the transmitted intensity of a signal beam within this range. Both the enhanced optical near-field associated with plasmonic modes and the strong non-linear optical response of J-aggregate would allow low control power and fast response to be achieved.

### 2. Laser

The laser may operate by using the plasmonic modes excited in the assemblies of one or more nanoparticles to stimulate the non-linear adsorbed material of the devices and generate stimulated emission. The device thus acts as a laser. The strong spatial localisation of surface plasmons modes leads to locally enhanced electromagnetic field intensities and allows the generation of a low input power laser. The geometry can be based on a coupled system such as the one in FIG. 1 in which both the pump and stimulated beams would be degenerate.

### 3. Electrically Switchable Plasmonic Filter

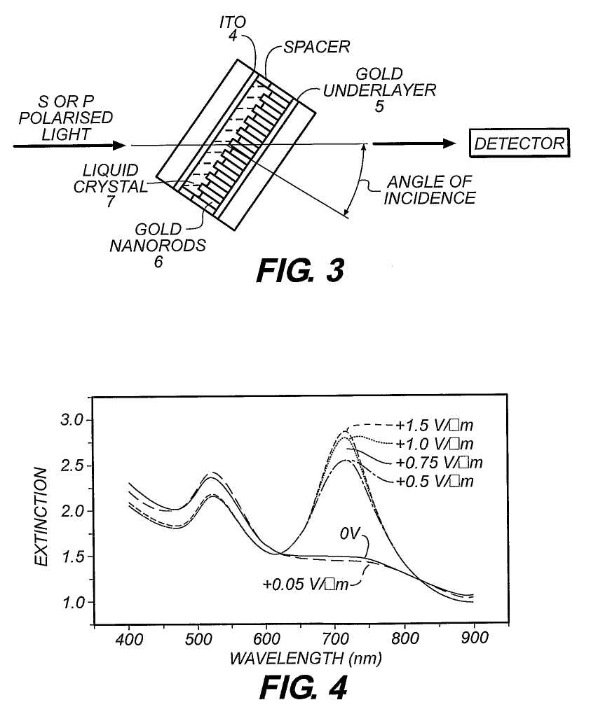

Aluminium with a small oxygen content is sputtered onto appropriate underlayers grown on a glass substrate. The aluminium is then anodised at 30V in 0.3M sulfuric acid to produce a porous alumina thin film and gold is subsequently electrodeposited into the pores to produce the gold nanorods 6, see FIG. 3. Next the cell for the liquid crystals is made by means of a 100 μm polymer spacer and an ITO covered glass slide (delta technologies 30-60 ohm) with the E7 (Merck™) liquid crystal 7 being inserted between by capillary action. Transmission spectra were measured using a Unicam UV4 spectrometer with the addition of a polariser in the incident beam. FIG. 3 shows the geometry used. Electrical contacts were made to the ITO 4 and the gold underlayer 5 using silver conducting epoxy and a voltage applied using a DC power supply. FIG. 4 shows the effect of the liquid crystal and applied field on the extinction spectra of 20 nm diameter and 400 nm long gold nanorods embedded in alumina obtained using p-polarised incident light at an angle of incidence of 400. Initially for a small field (0.05V/μm) there is an increase in the absorbance for the peak at 520 nm and a decrease in the absorbance at longer wavelength. As the voltage is increased (0.15V/μm) the absorbance for the peak at 520 nm decreases and the peak around 715 nm starts to appear which then rapidly increases as the voltage is increased to +0.5V/μm. As the field is increased further there is a steady increase in the longitudinal peak, which starts to saturate, but little more change in the absorbance of the transverse peak.

The invention has been described with reference to preferred embodiments thereof. It will be understood by those skilled in the art that variations and modifications can be effected within the scope of the invention.

1. A surface plasmon optical element comprising
an array of metal nanopillars or nanowires with an adsorbed layer of resonant material.

2. (canceled)

3. Surface plasmon optical element as in claim 1 where the resonant material is a non-linear material.

4. Surface plasmon optical element as in claim 1 where the resonant material is coherently coupled to the resonances of the nanopillars or nanowires.

5. Surface plasmon optical element as in claim 1 where the resonant material is a j-aggregate dye.

6. Surface plasmon optical element as in claim 1 where the resonant material is a liquid crystal.

7. Surface plasmon optical element as in claim 1 where the resonant material is a j-aggregate dye, where the absorbance wavelength of a substrate-adsorbed dye is shifted 10 nm, or more, relative to the absorbance wavelength measured for the molecularly dissolved dye in solution in the absence of the supporting substrate.

8. Surface plasmon optical element as in claim 7 where the resonant j-aggregate dye has the formula (I):— 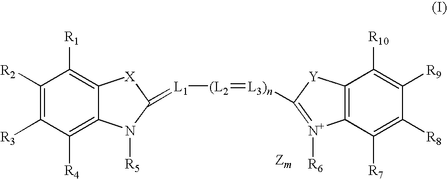
wherein
X and Y each independently represents O, S, Se, a NR group or CH═CH, wherein R represents an unsubstituted or substituted alkyl group, an unsubstituted or substituted aryl group or an unsubstituted or substituted heteroaryl group, with the proviso that at least one of X and Y is S;
R₁-R₄ and R₇-R₁₀ each independently represents hydrogen or a substituent selected from halogen, an unsubstituted or substituted alkyl or alkoxy group having from 1 to 6 carbon atoms, an unsubstituted or substituted aryl group having from 6 to 10 carbon atoms or an unsubstituted or substituted heteroaryl group having from 5 to 10 atoms which may include one or more atoms selected from N, S and O; wherein any two adjacent substituents in R₁-R₄ and R₇-R₁₀ may be taken together to form an unsubstituted or substituted ring;
R₅ and R₆ each independently represents an unsubstituted or substituted alkyl group having from 1 to 6 carbon atoms;
L₁, L₂ and L₃ each independently represents an unsubstituted or substituted methine group;
Z represents an inorganic or organic cation;
n is 0-3 and
m is 0 or 1.

9. Surface plasmon optical element as in claim 8 wherein X and Y is each S.

10. Surface plasmon optical element as in claim 8 wherein R₅ and R₆ are independently selected from 2-sulfoethyl, 3-sulfopropyl, 3-sulfobutyl, 4-sulfo-butyl, 2-hydroxy-3-sulfopropyl group, carboxymethyl carboxyethyl and carboxypropyl groups.

11. Surface plasmon optical element as in claim 8 wherein the dye is symmetrical about the methine chain.

12. Surface plasmon optical element as in claim 8 which has the structure:—

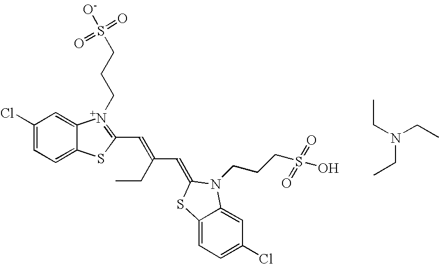

13. Use of a resonant material to activate an array of metal nanopillars or nanowires to function as a surface plasmon optical element.

14. Use of a resonant material to activate an array of metal nanopillars or nanowires to function as a surface plasmon optical element wherein the resonant material is j-aggregate dye.

15. Use of a liquid crystal material to activate an array of metal nanopillars or nanowires to function as an electrically tunable surface plasmon optical element.
